(19) United States
(12) Patent Application Publication
(10) Pub. No.: US 2007/0222127 A1
(43) Pub. Date: Sep. 27, 2007

(54) Threaded Plate Single Shear Mount Shock Absorber/Strut Mount

(76) Inventor: Landon Ball, North Augusta, SC (US)

Correspondence Address: HARNESS, DICKEY & PIERCE, P.L.C., P.O. BOX 828, BLOOMFIELD HILLS, MI, 48303, US

(21) Appl. No.: 11/277,275

(22) Filed: Mar. 23, 2006

(51) Int. Cl. F16F 5/00

(52) U.S. Cl. 267/140.13

(57) ABSTRACT

A shock absorber mounting system for a golf car includes a shock absorber having a connecting sleeve. A bushing is disposed within the connecting sleeve. A spacer sleeve having a through-aperture is received within and in contact with the bushing. A fastener having a shank with a threaded end is inserted through the through-aperture of the spacer sleeve with the threaded end engaged with a threaded aperture of a structural member of the golf car.

### FIELD

The present disclosure relates to a device and method for connecting suspension elements for golf car and off-road utility vehicles.

### BACKGROUND

The statements in this section merely provide background information related to the present disclosure and may not constitute prior art.

Golf cars and many off-road or utility vehicles, hereinafter “golf cars” commonly have suspension systems using shock absorbers to modify the frequency of suspension system deflection or dampen the deflection created by loads applied to either a leaf spring assembly or a coiled spring assembly. Assembly of the golf car is commonly accomplished in an assembly line format, with various elements of the suspension system pre-assembled or completed as the golf car assembly is completed. Common shock absorbers are mounted using a fastener inserted through a spacer tube which can be positioned within a resilient bushing. The resilient bushing is commonly disposed in a connecting sleeve. The connecting sleeve is positioned between the opposed walls of a clevis commonly provided as a U-shaped channel. Coaxially aligned fastener apertures are created in each of the opposed walls to receive the fastener. The fastener is then inserted into one of the wall apertures, through the connecting sleeve, exits through the opposed or second wall aperture and is secured with a nut.

Additional costs and delayed construction time can result from the current shock absorber installation. The nut must be co-axially aligned with the second wall aperture and either temporarily held for fastening, which increases installation complexity, or is fixed in alignment with the aperture by welding, which adds a construction step plus welding costs. The cost of the U-shaped channel includes the number of operations required to produce the required shape plus to create and coaxially align the wall apertures. A simpler clevis and mounting concept are therefore warranted to reduce construction costs.

### SUMMARY

According to several embodiments of the present disclosure, a shock absorber mounting system for a golf car includes a shock absorber having a connecting sleeve. A bushing is disposed within the connecting sleeve. A spacer sleeve having a through-aperture is disposed within and in contact with the bushing. A fastener having a shank with a threaded end is inserted through the through-aperture of the spacer sleeve with the threaded end engaged with a threaded aperture of a structural member of the golf car.

According to other embodiments, a shock absorber mounting system for a golf car includes a shock absorber having a connecting sleeve. A bushing is disposed within the connecting sleeve. A spacer sleeve has a through-aperture. The spacer sleeve is received within and is in contact with the bushing. A fastener having a shank with a threaded end is inserted through the through-aperture of the spacer sleeve with the threaded end engaged with a threaded aperture of a structural member of the golf car.

According to still other embodiments, a shock absorber mounting system for a golf car includes a shock absorber having opposed first and second connecting sleeves. Each of the connecting sleeves includes a bushing, a spacer sleeve having a through-aperture being disposed within and in contact the bushing. A first fastener is disposed within the spacer sleeve of the first connecting sleeve having a threaded end extending outward from the spacer sleeve. A second fastener is disposed within the spacer sleeve of the second connecting sleeve having a threaded end extending outward from the spacer sleeve. A structural member of the golf car has a first threaded aperture operable to receive the threaded end of the first fastener to fastenably engage the first connecting sleeve to the structural member. A connecting member has a second threaded aperture operable to receive the second fastener to fastenably engage the second connecting sleeve to the connecting member.

According to yet still other embodiments, a golf car includes a frame having a frame extension member. A suspension system is supported from the frame having a connecting member fixedly connected to an axle housing. A shock absorber is connected between the frame and the suspension system. The shock absorber includes a first connecting sleeve having a first bushing in contact with the first connecting sleeve and a first spacer sleeve disposed within the first connecting sleeve. A second connecting sleeve has a second bushing in contact with the second connecting sleeve and a second spacer sleeve disposed within the second connecting sleeve. A first fastener is inserted through the first spacer sleeve and threadably engaged at a first threaded end with a threaded aperture of the frame extension member. A second fastener is inserted through the second spacer sleeve and threadably engaged at a second threaded end with a threaded aperture of the connecting member.

According to yet further embodiments, a method for connecting a shock absorber to a golf car, the shock absorber having a connecting sleeve, a bushing, a spacer sleeve having a through-aperture, and a fastener, the golf car having a structural member with a threaded aperture includes positioning the bushing within and in contact with the connecting sleeve. The method further includes inserting the spacer sleeve within and in contact with the bushing. The method still further includes sliding the fastener into the through-aperture of the spacer sleeve until a threaded end of the fastener extends beyond the spacer sleeve. The method yet further includes threadably engaging the threaded end with the threaded aperture of the structural member.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having the threaded plate single shear mount shock absorber/strut mount according to various embodiments of the present disclosure;

FIG. 2 is a bottom plan view of the golf car of FIG. 1;

FIG. 3 is a partial perspective view of an assembly including a vehicle frame, rear suspension system and the threaded plate single shear mount shock absorber/strut mount of the present disclosure;

FIG. 4 is a partial cross sectional view taken at section 4-4 of FIG. 3; and

FIG. 5 is a partial cross sectional view taken at section 5-5 of FIG. 3.

### DETAILED DESCRIPTION

The following description is merely exemplary in nature and is in no way intended to limit the present disclosure, application, or uses. Throughout this specification, like reference numerals will be used to refer to like elements. As referred to herein, the term “golf car” is synonymously used to describe application of the present disclosure to golf cars as well as small (off road) sport utility vehicles such as modified golf cars, used for example as food and/or beverage cars, golf cars adapted for use as hunting/sporting clays vehicles, golf course maintenance vehicles, and the like.

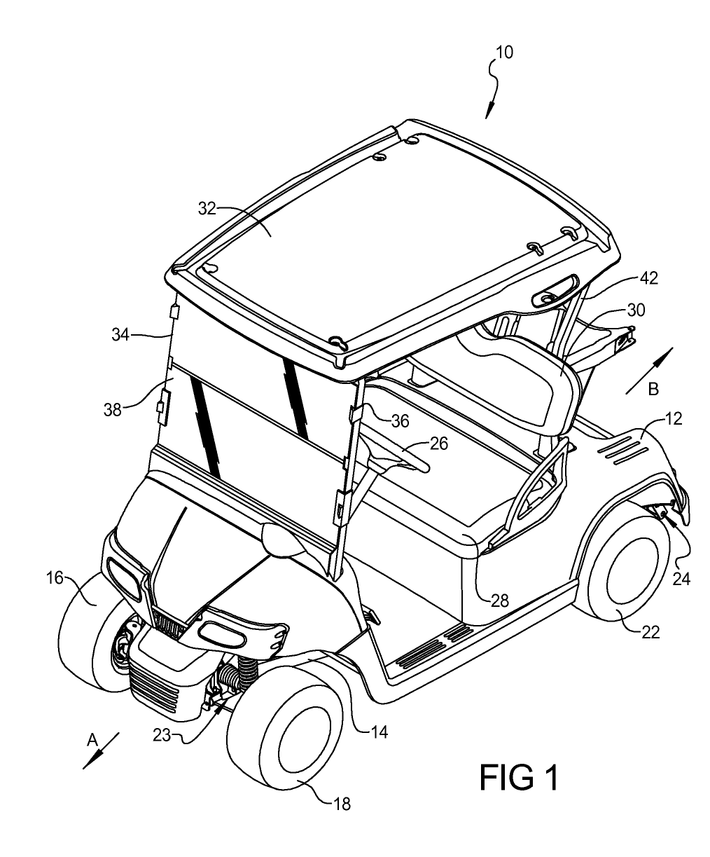

Referring generally to FIG. 1, a golf car 10 can include a body 12 supported from a structural frame 14. Frame 14 can also support a plurality of wheels including a first steerable wheel 16 and a second steerable wheel 18. In addition, powered or driven wheels including a first driven wheel 20 and a second driven wheel 22 are commonly connected to a rear structural portion of frame 14. A front suspension system 23 can also be provided which is adapted for supporting each of the first and second steerable wheels 16, 18. A rear suspension system 24 can also be provided which is adapted for supporting each of the first and second driven wheels 20, 22 from frame 14. A steering mechanism 26 which commonly includes a steering wheel and a support post assembly is also included to provide the necessary steering input to first and second steerable wheels 16, 18.

Golf car 10 can also include a passenger bench seat 28 and a passenger back support cushion 30. A cover or roof 32 can also be provided which is supported from either body 12 or frame 14 by first and second support members 34, 36. A windscreen or windshield 38 can also be provided which is also supported by each of first and second support members 34, 36. A rear section of roof 32 can be supported by each of a first and a second rear support element 40, 42. Other items provided with golf car 10 include golf bag support equipment, accessory racks or bins, headlights, side rails, fenders, and the like.

Golf car 10 is commonly propelled by a power unit such as an engine or battery/motor system which is commonly provided below and/or behind bench seat 28. Golf car 10 is capable of motion in either of a forward direction “A” or a rearward direction “B”. Each of first and second driven wheels 20, 22 can be commonly supported to frame 14 using rear suspension system 24. Each of first and second steerable wheels 16, 18 can be independently or commonly supported to frame 14.

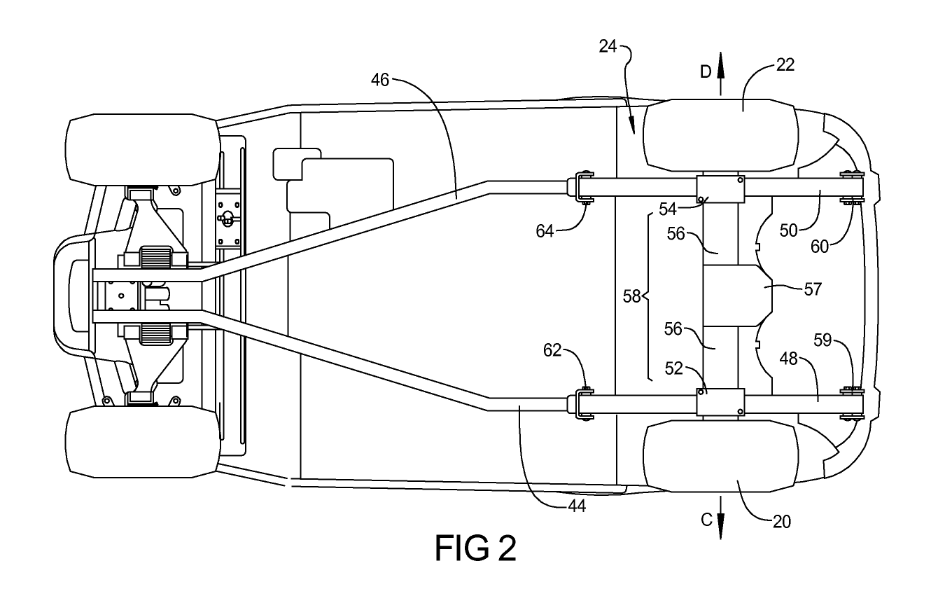

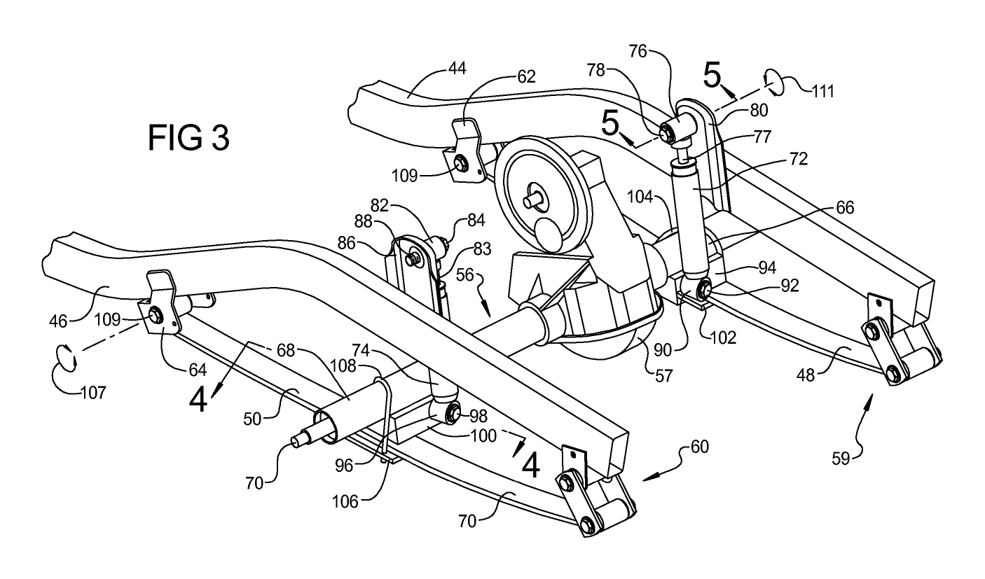

As best seen in reference to FIG. 2, frame 14 can further include a first frame member 44 and a second frame member 46. First and second frame members 44, 46 can be hollow, tubular shaped members created of a steel material or similar structural material and formed by welding, extruding, hydroforming, or similar processes. In several embodiments, a first and second leaf spring 48, 50 can support each of first and second driven wheels 20, 22. A first leaf spring/shock support assembly 52 can be connected to first leaf spring 48 and first frame member 44. Similarly, a second leaf spring/shock support assembly 54 can be connected to second leaf spring 50 and second frame member 46. Each of first and second leaf spring/shock support assemblies 52, 54 are also connected to an axle housing 56 within which an axle (shown in FIG. 3) is rotatably disposed for providing driving power to the first and second driven wheels 20, 22 through a gear train or transmission 57 connected to the power unit.

First and second leaf springs 48, 50 can be connected at a rearward facing end to first and second frame members 44, 46 by each of a first and second link assembly 59, 60. In addition, first and second leaf springs 48, 50 can be connected at a forward facing end to first and second frame members 44, 46 by each of a first and second bracket assembly 62, 64. The use of first and second leaf springs 48, 50 further helps reduce deflection of the rear suspension system 24 in either of a first or second deflection direction “C” or “D”.

Referring now to FIG. 3, multiple components of the rear drive assembly 58 include transmission 57 which divides axle housing 56 into each of a first housing portion 66 and a second housing portion 68. A one or multiple part axle 70 extending beyond distal ends of axle housing 56 is rotatably disposed within axle housing 56. Rotation of axle 70 by transmission 57 provides the rotating drive for first and second driven wheels 20, 22.

According to several embodiments, rear suspension system 24 can further include a first shock absorber 72 and a second shock absorber 74. First shock absorber 72 can include a first connecting sleeve 76 extending from a piston rod 77, the first connecting sleeve 76 being connected using a fastener 78 to a threaded aperture (not clearly visible in FIG. 3) previously created in first frame extension 80. First frame extension 80 can be a structural element which can be fixedly connected to first frame member 44 for example by welding. Similarly, second shock absorber 74 can include a second connecting sleeve 82 extending from a piston rod 83, the second connecting sleeve 82 being connected to a threaded aperture 88 created in a second frame extension 86 similar in design to first frame extension 80 but fixedly connected to second frame member 46. First shock absorber 72 can further include a third connecting sleeve 90 which is connected similar to fasteners 78 and 84 using a fastener 92 threadably received in a first connecting member 94. Similarly, second shock absorber 74 can include a fourth connecting sleeve 96 threadably connected by a fastener 98 to a second connecting member 100.

First connecting member 94 can be positioned between first housing portion 66 and a first support plate 102. In several embodiments, first leaf spring 48 is frictionally engaged or sandwiched between first support plate 102 and first connecting member 94 using a first U-shaped bolt 104. Similarly, second connecting member 100 can be positioned between second housing portion 68 and a second support plate 106. Second leaf spring 50 can be sandwiched between second connecting member 100, and second support plate 106 using a second U-shaped bolt 108.

Each of the first and second leaf springs 48, 50 can be connected such as by fastening or pinning to respective ones of first and second frame members 44, 46 using first and second bracket assemblies 62, 64. First and second bracket assemblies 62, 64 can be welded or otherwise fixedly connect to the first or second frame member 44, 46. Each of the first and second leaf springs 48, 50 can be connected at their aft facing ends such as by fastening or pinning to respective ones of first and second frame members 44, 46 using first and second link assemblies 59, 60. First and second link assemblies 59, 60 permit limited motion in forward or rearward directions “A” or “B” as the first and second leaf springs 48, 50 deflect vertically due to loads received through first and second driven wheels 20, 22 transferred to axle housing 56. This vertical displacement also includes a small component of rotation or rotational arc 107 about a fastener 109 used to mount each of first and second bracket assemblies 62, 64. Arc of rotation 109 translates into a minor arc of rotation 111 about a longitudinal axis of fasteners 78 and 84 which can be accommodated by corresponding rotation of first and second connecting sleeves 76 and 82 with respect to fasteners 78 and 84.

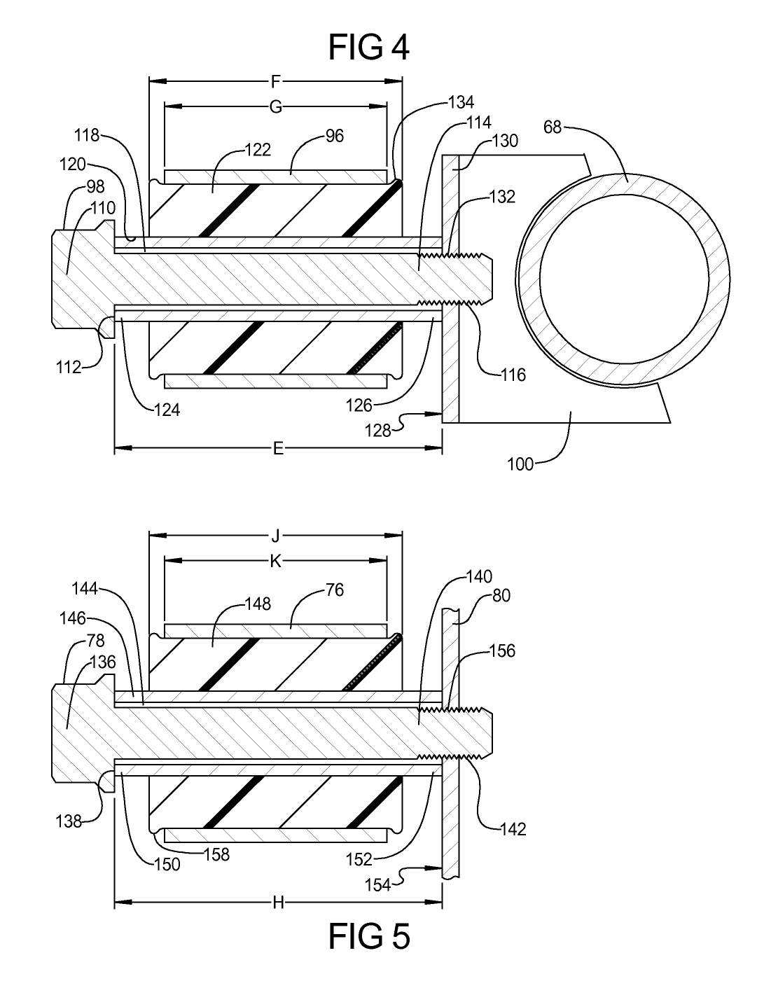

Referring now to FIG. 4, an installation of fastener 98 joining fourth connecting sleeve 96 to second connecting member 100 is similar to the installation of third connecting sleeve 90 using fastener 92, therefore further discussion will be provided for fourth connecting sleeve 96 only. Fastener 98 includes a head 110 having for example a hexagonal shape or similar multi-sided geometric shape, a female keyed slot, or the like. An engagement face 112 of fastener head 110 faces a shaft or shank 114 which provides a distally located threaded end 116. Shank 114 is slidably disposed through a through-aperture 118 of a spacer sleeve 120. Spacer sleeve 120 and fastener 98 are created of one or more metal materials such as steel, aluminum, or the like. Spacer sleeve 120 is a substantially tubular shaped member received in a corresponding aperture of a resilient bushing 122, with an outer wall of tubular shaped member 120 being in physical contact with resilient bushing 122 substantially throughout a length “F” of bushing 122. In several embodiments, end portions of spacer sleeve 120 extend beyond bushing 122 at opposite ends of bushing 122. In several embodiments, bushing 122 can be bonded to spacer sleeve 120. Resilient bushing 122 can be a rubber material, a resilient polymeric material, or combination of resilient materials. Bushing 122 is received within and contacts an inner wall of fourth connecting sleeve 96.

To connect fourth connecting sleeve 96 to second connecting member 100, shank 114 is slidably received within through-aperture 118 until engagement face 112 of fastener head 110 abuts a first end 124 of spacer sleeve 120, and a second end 126 of spacer sleeve 120 abuts an outer face 128 of a contact wall 130 of second connecting member 100. Threaded end 116 of fastener 98 extends beyond both spacer sleeve 120 and second connecting member 100 and is threadably engaged within a threaded aperture 132 previously created through contact wall 130. In several embodiments, threaded end 116 has a threaded portion that begins within through-aperture 118 and extends beyond both second end 126 and contact wall 130 to allow meta-to-metal engagement of first and second ends 124, 126 of spacer sleeve 120 before threaded end 116 is fully engaged within threaded aperture 132. Second connecting member 100 and first connecting member 94 are fixedly connected such as by welding to axle housing 56 at either first or second housing portion 66, 68.

The connection of second connecting member 100 to second housing portion 68 using spacer sleeve 120 is defined by a sleeve length “E” of spacer sleeve 120. Sleeve length “E” is greater than both bushing length “F” and a connecting sleeve length “G”. Clearance at both ends of bushing 122 and fourth connecting sleeve 96 is therefore provided by sleeve length “E”. This clearance prevents either bushing 122 or fourth connecting sleeve 96 from engaging either engagement face 112 or outer face 128. In several embodiments, bushing length “F” is greater than connecting sleeve length “G”, resulting in bulbous ends 134 of bushing 122 extending radially outward with respect to an inner wall of fourth connecting sleeve 96, which help retain a relative position of fourth connecting sleeve 96 with respect to bushing 122.

Referring now to FIG. 5, an installation of fastener 78 joining first connecting sleeve 76 to first frame extension 80 is similar to the installation of second connecting sleeve 82 using fastener 84 to second frame extension 86, therefore further discussion is provided for first connecting sleeve 76 only. Fastener 78 includes a head 136 having for example a hexagonal shape or a geometric shape adapted to be engaged by an installation tool, a female keyed slot, or the like. An engagement face 138 faces a shaft or shank 140 which provides a distally located threaded end 142. Shank 140 is slidably disposed through a bore or through-aperture 144 of a spacer sleeve 146. Spacer sleeve 146 and fastener 78 are each created of one or more metal materials such as steel, aluminum, or the like. Spacer sleeve 146 is received in a corresponding aperture of a resilient bushing 148 and can contact the bushing 148. Resilient bushing 148 can be a rubber, a polymeric material, or a combination of resilient materials. Bushing 148 is received within first connecting sleeve 76.

To connect first connecting sleeve 76 to first frame extension 80, shank 140 is slidably disposed within through-aperture 144 until engagement face 138 of fastener head 136 abuts a first end 150 of spacer sleeve 146, and a second end 152 of spacer sleeve 146 abuts an engagement wall or outer face 154 of first frame extension 80. Threaded end 142 of fastener 78 is threadably engaged within a threaded aperture 156 previously created through first frame extension 80. First frame extension 80 and second frame extension 86 are fixedly connected such as by welding to one of first or second frame members 44, 46. In this view, the connection of first frame extension 80 to first frame member 44 is shown. A sleeve length “H” of spacer sleeve 146 is greater than both a bushing length “J” and a connecting sleeve length “K” to prevent either bushing 148 or first connecting sleeve 76 from engaging either engagement face 138 or outer face 154.

In several embodiments, bushing length “J” is greater than connecting sleeve length “K”, resulting in bulbous ends 158 of bushing 148 extending radially outward with respect to an inner wall of first connecting sleeve 76, which help retain a relative position of first connecting sleeve 76 with respect to bushing 148. In several embodiments, threaded end 142 of fastener 78 has a threaded portion partially positioned within the through-aperture 144 of spacer sleeve 146 to allow meta-to-metal engagement of first and second ends 150, 152 of spacer sleeve 146 before rotation of fastener 78 causes threaded end 142 to be fully engaged within threaded aperture 156.

By eliminating the need for a nut at contact wall 130 or outer face 154, additional part costs and installation costs are saved. The nut of existing installations must be positioned before the first or second connecting members are fixed to axle housing 56, which impacts the assembly sequencing. The use of a threaded aperture and a single mount wall in place of the combination of a nut and a pair of coaxially aligned apertures in opposed clevis walls to receive fasteners 78, 84, 92, and 98 eliminates the nut plus half of the previous installation clevis. The present disclosure also permits the threaded aperture to be created at any point during construction of golf car 10, and if desirable, after installation of first and second frame extensions 80, 86 or first and second connecting members 94, 100. Further, the use of extension sleeves of the present disclosure provides clearance for rotation of the first, second, third, and fourth connecting sleeves 76, 82, 90, and 96. The ability to create the threaded apertures of the present disclosure at different phases of construction/assembly of golf car 10 therefore provides the ability to compensate for construction tolerances or misalignment of the connecting members or frame extension members.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A shock absorber mounting system for a golf car, comprising:
a shock absorber having a connecting sleeve;
a bushing disposed within the connecting sleeve;
a spacer sleeve having a through-aperture, the spacer sleeve disposed within and in contact with the bushing;
a fastener having a shank with a threaded end and a head opposed to the threaded end, the shank inserted through the through-aperture of the spacer sleeve with the threaded end engaged with a threaded aperture of a structural member of the golf car and the head engaged with the spacer sleeve.

2. The system of claim 1, wherein the bushing further comprises a resilient material.

3. The system of claim 2, wherein the resilient material further comprises one of a rubber and a synthetic rubber material.

4. The system of claim 1, wherein the structural member comprises a frame member.

5. The system of claim 4, wherein the frame member further comprises a frame extension member fixedly connected to the frame member.

6. The system of claim 1, wherein the structural member comprises a connecting member fixedly connected to an axle housing.

7. The system of claim 6, wherein the threaded aperture is created in a wall of the connecting member.

8. The system of claim 1, wherein the fastener further comprises a bolt.

9. The system of claim 8, wherein the head of the bolt further comprises an engagement face positioned in contact with a first end of the spacer sleeve.

10. The system of claim 9, wherein a second end of the spacer sleeve is positioned in contact with the structural member when the shank is disposed through the through-aperture of the spacer sleeve.

11. The system of claim 1, wherein the spacer sleeve comprises a substantially tubular shaped member having a length greater than both a connecting sleeve length and a bushing length.

12. The system of claim 11, wherein the bushing length is greater than the connecting sleeve length and the bushing further defines a bulbous end extending beyond the connecting sleeve.

13. The system of claim 12, wherein the length of the spacer sleeve defines a first clearance proximate a first end of the spacer sleeve between a head of the fastener and the bushing, and a second clearance proximate a second end of the spacer sleeve between the bushing and the structural member, the first and second clearances permitting rotation of the connecting sleeve with respect to the structural member.

14. A shock absorber mounting system for a golf car, comprising:
a shock absorber having oppositely positioned first and second connecting sleeves, each of the connecting sleeves including:
a bushing; and
a spacer sleeve having a through-aperture, the spacer sleeve disposed within and in contact with the bushing;
a first fastener disposed within the spacer sleeve of the first connecting sleeve having a first threaded end extending outward from the spacer sleeve;
a second fastener disposed within the spacer sleeve of the second connecting sleeve having a second threaded end extending outward from the spacer sleeve;
a structural member of the golf car having a first threaded aperture operable to receive the first threaded end of the first fastener to fastenably engage the first connecting sleeve to the structural member; and
a connecting member having a second threaded aperture operable to receive the second threaded end of the second fastener to fastenably engage the second connecting sleeve to the connecting member.

15. The system of claim 14, wherein the spacer sleeve of each of the first and second connecting sleeves comprises a substantially tubular shaped member having a spacer sleeve length greater than both a connecting sleeve length and a bushing length.

16. The system of claim 15, wherein the bushing length is greater than the connecting sleeve length and the bushing further comprises a bulbous end extending beyond each of the first and second connecting sleeves.

17. The system of claim 16, wherein the spacer sleeve length defines a first clearance proximate a first end of the spacer sleeve between a head of one of the first and second fasteners and the bushing.

18. The system of claim 17, wherein the spacer sleeve length defines a second clearance proximate a second end of the spacer sleeve between the bushing and each of the structural member and the connecting member, wherein the first and second clearances permit rotation of the first connecting sleeve with respect to the structural member and the second connecting sleeve with respect to the connecting member.

19. The system of claim 17, wherein each of the first and second fasteners further comprise a shank having the threaded end extending from the shank and a head positioned opposite from the threaded end, the shank being slidably received within the through-aperture of the spacer sleeve.

20. The system of claim 19, wherein the first and second threaded ends of the first and second fasteners are each partially positioned within the through-aperture of the spacer sleeve to allow meta-to-metal engagement of both the first and second ends of the spacer sleeve before the threaded end is fully engaged within the threaded aperture.

21. The system of claim 14, further comprising an axle housing operable to rotatably support opposed driven wheels, the connecting member fixedly connected to the axle housing.

22. A golf car, comprising:
a frame;
a suspension system supported from the frame, the suspension system having a connecting member;
a shock absorber connected between the frame and the suspension system, the shock absorber including:
a first connecting sleeve having a first bushing in contact with the first connecting sleeve and a first spacer sleeve disposed within the first connecting sleeve; and
a second connecting sleeve having a second bushing in contact with the second connecting sleeve and a second spacer sleeve disposed within the second connecting sleeve;
a first fastener inserted through the first spacer sleeve and threadably engaged at a first threaded end with a first threaded aperture of the frame; and
a second fastener inserted through the second spacer sleeve and threadably engaged at a second threaded end with a second threaded aperture of the connecting member.

23. The golf car of claim 22, further comprising an axle housing having an axle rotatably connected to opposed driven wheels.

24. The golf car of claim 23, wherein the connecting member is fixedly connected to the axle housing.

25. The golf car of claim 24, further comprising a leaf spring coupled to the connecting member and connected at opposed ends to the frame.

26. The golf car of claim 22, wherein the frame further comprises a frame extension member fixedly connected to the frame, the frame extension member having the first threaded aperture created therethrough.

27. The golf car of claim 22, wherein each of the first and second connecting sleeves further comprise a sleeve length shorter than a bushing length of both the first and second bushings, and wherein the first and second connecting sleeves have a sleeve length greater than the bushing length.

28. A method for connecting a shock absorber to a golf car, the shock absorber having a connecting sleeve, a bushing, a spacer sleeve having a through-aperture, and a fastener, the golf car having a structural member with a threaded aperture, the method comprising:
positioning the bushing within and in contact with the connecting sleeve;
inserting the spacer sleeve within and in contact with the bushing;
sliding the fastener into the through-aperture of the spacer sleeve until a threaded end of the fastener extends beyond the spacer sleeve; and
threadably engaging the threaded end with the threaded aperture of the structural member.

29. The method of claim 28, further comprising rotating the fastener until opposite ends of the spacer sleeve are engaged in metal-to-metal contact with both the fastener and the structural member.

30. The method of claim 28, further comprising partially positioning the threaded end within the through-aperture of the spacer sleeve to allow metal-to-metal contact of first and second ends of the spacer sleeve before the threaded end is fully engaged within the threaded aperture.

31. The method of claim 28, further comprising positioning the bushing on the spacer sleeve with opposed ends of the bushing both spaced from one of the first and second ends of the bushing.
